(19) United States
(12) Patent Application Publication
(10) Pub. No.: US 2009/0289913 A1
(43) Pub. Date: Nov. 26, 2009

(54) TERMINAL HAVING TOUCHSCREEN AND METHOD FOR SEARCHING DATA THEREOF

(75) Inventors: Min-Young CHANG, Seoul (KR); Hyung Min Yook, Seoul (KR); Seung Wook Nam, Bucheon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/465,389

(22) Filed: May 13, 2009

(30) Foreign Application Priority Data
May 22, 2008 (KR) 10-2008-0047652

(51) Int. Cl. G06F 3/041; G06F 3/048

(52) U.S. Cl. 345/173; 715/787

(57) ABSTRACT

A terminal equipped with a touchscreen and data search method using the touchscreen is provided. The data search method displays a list of data items and a scroll button in first and second display regions defined on the touchscreen, respectively, checks, when a touch is detected on the scroll button, a part of the second region at which the scroll button is placed, presents a value of tag information matched with the part, and displays at least one data item identified by the value of the tag information in the first display region.

### CROSS REFERENCE TO RELATED APPLICATION

This application claims priority from and the benefit of Korean Application No. 10-2008-0047652, filed on May 22, 2008, which is hereby incorporated by reference for all purposes as if fully set forth herein.

### BACKGROUND OF THE INVENTION

1. Field of the Invention

The present invention relates to a mobile terminal and, in particular, to a terminal equipped with a touchscreen and a data search method using the touchscreen.

2. Discussion of the Background

Touchscreen is becoming more common in various terminals due to its advantage in being able to be implemented as display and input devices simultaneously. Since it can replace other types of input devices, the touchscreen is useful in small compact devices such as mobile terminals.

In the meantime, as the use of mobile terminals is growing at a rapid pace, the mobile terminals are evolving to multifunctional devices to satisfy diverse user requirements. These include video communication, messaging, camera, digital broadcast reception, MP3 playback, and Bluetooth functions, as well as basic voice communication functions. As the supplementary functions are diversified, the mobile terminal has to process and store various and large amounts of data.

With the diversification of data types and the increase of data amount stored in the mobile terminal, it has become more complicated for a user to search for specific data. Typically, a data search is performed by navigating the data one by one or entering a keyword for the target data. However, such conventional data search methods are time consuming and labor intensive. Even in the touchscreen-enabled mobile terminal, the keyword input data search method may be inconvenient when the user has to call an input system for entering the keyword.

### SUMMARY OF THE INVENTION

Exemplary embodiments of the present invention provide a mobile terminal having a touchscreen and a touchscreen supported data search method of the mobile terminal that may reduce data search time.

Additional features of the invention will be set forth in the description which follows, and in part will be apparent from the description, or may be learned by practice of the invention.

An exemplary embodiment of the present invention discloses a data search method for a terminal having a touchscreen including displaying a list of data items and a scroll button in first and second display regions defined on the touchscreen, respectively; checking, when a touch is detected on the scroll button, a current part of the second region at which the scroll button is placed; presenting a value of tag information matched with the current part; and displaying, when the touch is released on the scroll button, at least one data item identified by the value of the tag information in the first display region.

An exemplary embodiment of the present invention discloses a terminal including a touchscreen which defines a first display region for displaying a list of data items and a second display region for displaying a scroll button, the touchscreen sensing touch thereon; a storage unit which stores the data items with values of tag information for sorting the data items; and a control unit which checks, when a touch is detected on the scroll button, a part of the scroll button in the second display region, presents the value of the tag information matched with the part, and displays, when the touch is released on the scroll button, at least one data item identified by the value of the tag information in the first display region.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a touchscreen of a mobile terminal according to an exemplary embodiment of the present invention.

FIG. 2A, FIG. 2B, FIG. 2C, FIG. 3A, FIG. 3B and FIG. 3C are diagrams illustrating steps of a data search method according to an exemplary embodiment of the present invention.

FIG. 4 is a diagram illustrating an exemplary screen image displaying tag information corresponding to the movement of the scroll button according to an exemplary embodiment of the present invention.

FIG. 5A and FIG. 5B are diagrams illustrating exemplary screen images displayed on a touchscreen on which a data search is performed according to an exemplary embodiment of the present invention.

FIG. 6 is a block diagram illustrating a configuration of a mobile terminal having a touchscreen according to an exemplary embodiment of the present invention.

FIG. 7 is a flowchart illustrating a data search procedure using a scroll button provided in a touchscreen-enabled mobile terminal according to an exemplary embodiment of the present invention.

FIG. 8 is a flowchart illustrating a data search procedure using a data search region provided in the touchscreen-enabled mobile terminal according an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

In the following description, the term “terminal” denotes a data processing device which can generate and store data. For example, the terminal can be any of a personal computer, a laptop computer, a mobile phone, a digital camera, and an MP3 player, particularly having a touchscreen. In a preferred embodiment, the terminal is a mobile terminal having a touchscreen.

The term “touchscreen” denotes a device integrating an input module for inputting data and a display module for displaying data.

The term “data” includes all of the types of data created in the mobile terminal and downloaded from other terminals, for example, photos, audio files, text files, and video files. The text files include text messages. Text messages may include a short messaging service message, an instant message, a multimedia message received from or transmitted to another terminal, a document composed in a computer or downloaded through the internet, etc.

The term “tag information” denotes information for sorting the data such as creation time, storage location, name of the data and the like. Here, the time can be composed of year, month, date, hour, minute, second, tenths of second, etc. In the exemplary case of a photo, its tag information preferably includes a photo album, creation time stamp and the like. In the exemplary case of an audio file such as a song, the tag information preferably includes a singer, album title, album cover photo, genre and the like. In the exemplary case of a text message, preferably, its tag information includes text message type, created time, name of the text message, etc. The tag information may include the initials of the name of the data assigned by a program or user.

The tag information can be used for sorting the data. For example, the photos can be sorted in order of creation time or in alphabetic order according to the initials of the names of the data. For example, the tag information can be metadata.

The term “touch” denotes an action in which a finger or a stylus is put onto the touchscreen.

The term “release” denotes an action in which the finger or the stylus put on the touchscreen is separated from the touchscreen.

The term “tap” denotes an action in which a finger or a stylus is contacted onto the touchscreen and then released in a predetermined time.

The term “flick” denotes an action in which a finger or a stylus is contacted onto the touchscreen and then, with a short and sudden movement in a direction, released.

FIG. 1 is a diagram illustrating a touchscreen of a mobile terminal according to an exemplary embodiment of the present invention.

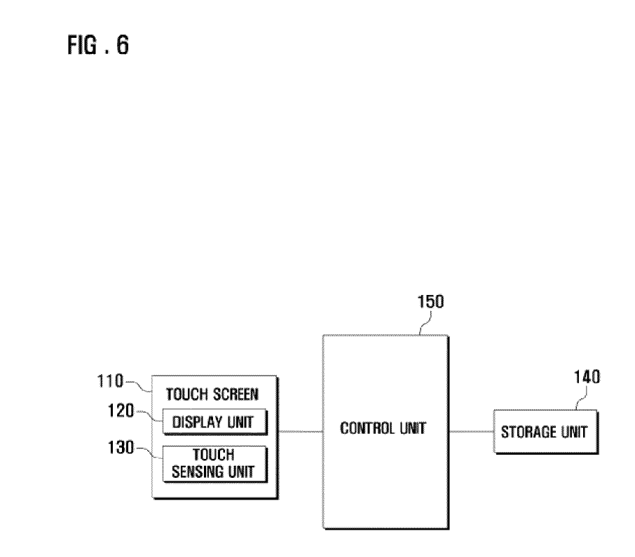

When one of a photo view mode, a message view mode, and a music view mode is selected, the mobile terminal controls a touchscreen 110 (see FIG. 6) to display on a display unit 120 a list of data items supported by the selected data mode as shown in FIG. 1. The touchscreen 110 provides a data display region 123 and a scroll region 125. The data items listed in the data display region 123 are sorted in order of a specific tag information. For example, the data items can be listed in alphabetical order as shown in FIG. 1 or in a chronological order such as according to the time when the data item was created (created time), last accessed, or changed by a program or a user. Accordingly, in an optional embodiment, the data items can be listed in reverse alphabetical or chronological order.

The scroll region 125 is a virtual region having a scroll button 127 to scroll the list of items up and down when the scroll button is touched and moved in the scroll region 125 by the finger or stylus moving on the touch screen 110 prior to release. Although depicted along the right side 120a of the touchscreen 110 in FIG. 1, the scroll region 125 can be implemented at any specific area on the touchscreen 110 according to the user's configuration or manufacturer's settings. In embodiments where the scroll region 125 is implemented at a top side 120b or a bottom side 120c of the touchscreen 110, the scroll button 127 may be placed to move left and right along the horizontal scroll region. In an embodiment where the scroll region 125 is implemented at a left side 120d or the right side 120a, the scroll button 127 may be placed to move up and down along the vertical scroll region.

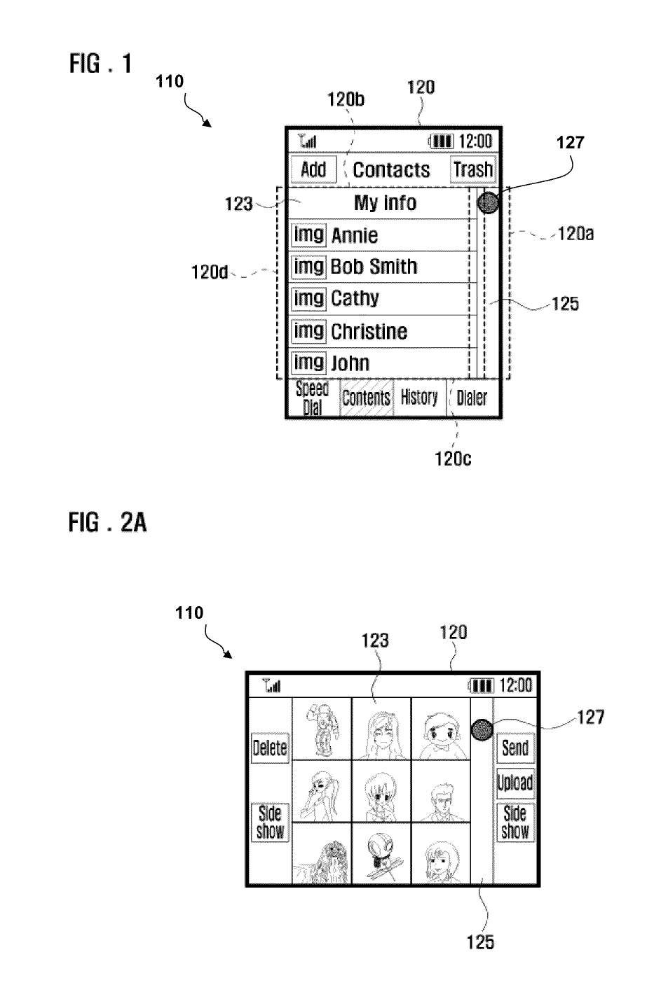

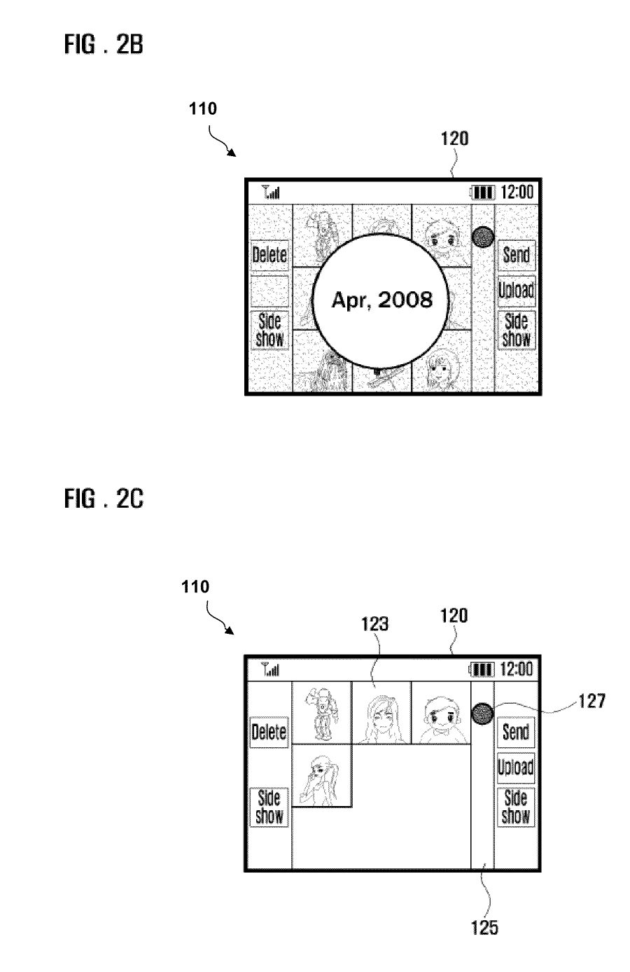

The touchscreen 110 can be configured to display the data items matched with the position of the scroll button 127 on the scroll region 125. The mobile terminal detects the movement of the scroll button 127 and controls the touchscreen to display the data items matched with the position of the scroll button 127. That is, one or more data items may have the same tag information (FIG. 2A). For this purpose, the scroll region 125 is partitioned into the number of values of the tag information and matches the partitioned parts of the scroll region 125 with respective values of tag information. For example, when the scroll button 127 position matches that of a tag information value with more than one data items having that particular tag information, the scroll button position matches those more than one data items.

For example, when 10 values of the tag information exist for sorting the data stored in the mobile terminal, the scroll region 125 is divided into 10 parts each indicating an individual value of tag information. Also, the values of tag information can be matched with movement distances of the scroll button 127, e.g. movement distances between 0 and 1 mm for a tag information value 1, between 1 and 3 mm for a tag information value 2, and between 3 and 5 mm for a tag information value 3. When the movement of the scroll button 127 along the scroll region is detected, the tag information value matched with the current position or the movement distance of the scroll button 127 is displayed in an enlarged form (FIG. 2B). If the touch on the scroll button 127 is released, the data items having the same value of the tag information at the position at which the touch is released are displayed. In an embodiment where a tag information value is created or deleted due to the addition or deletion of specific data (data items), the scroll region 125 can be reconfigured to reflect the change of tag information.

As the scroll button 127 moves while multiple data items are displayed in the display region 123, the control unit of the mobile terminal checks the value of tag information corresponding to the current position or the movement distance of the scroll button 127 and displays the value of tag information matched with the position on the touchscreen 110. The data search method according to an exemplary embodiment of the present invention will now be described in more detail with reference to FIG. 2A, FIG. 2B, FIG. 2C, FIG. 3A, FIG. 3B and FIG. 3C.

FIG. 2A, FIG. 2B, FIG. 2C, FIG. 3A, FIG. 3B and FIG. 3C are diagrams illustrating steps of a data search method according to an exemplary embodiment of the present invention.

FIG. 2A, FIG. 2B and FIG. 2C are images of the touchscreen displaying photos (images) as data items stored with created times as tag information. In the embodiment illustrated in FIG. 2A, FIG. 2B and FIG. 2C, created time includes year and month. As shown in FIG. 2A, the screen is composed of a data display region 123 arranging multiple photos and a scroll region 125 having a scroll button 127. The scroll button 127 moves along the scroll region 125 such that the value of tag information matched with the current position of the scroll button 127 is presented (displayed, e.g. as an image and/or text) on the entire screen or in the data display region 123 as shown in FIG. 2B. For example, if the current position or the movement distance of the scroll button 127 is matched with the value of tag information “April 2008,” the tag information value “April, 2008” is displayed on the touchscreen 110 in an enlarged form as shown in FIG. 2B. Afterward, the photos having the same tag information, e.g. the photos created in April, 2008, are displayed as shown in FIG. 2C.

FIG. 3A, FIG. 3B and FIG. 3C illustrate the touchscreen displaying music files as data items stored with album titles as tag information. As shown in FIG. 3A, the music files are grouped by tag information and per tag music file groups are listed in the data display region 123. The music files can be grouped by tag information such as playlist, artist, genre, album, and data type (all audio files). When the albums tag information is selected from the group list, an album list listing albums is displayed in the data display region 123 as shown in FIG. 3B together with a scroll button 127 on the scrolling region 125. As the scroll button 127 moves along the scrolling region 125, a cover image of the album matched with the current position or the movement distance of the scroll button 127 is displayed as shown in FIG. 3C.

In an exemplary embodiment, the data are sorted in an alphabetical order of the names of the data and the tag information is the first letter of the name of the data. In this case, the data are listed in order of names indicating the data on the data display region 123. As the scroll button 127 moves along the scroll region 125, the initial letter matched with the part at which the scroll button 127 is positioned is displayed on the touchscreen 110 in an overlaid manner. The first letter can be a special character or a numeric character. Accordingly, the scroll region 125 is divided into the number of the first letters including alphanumeric and special characters.

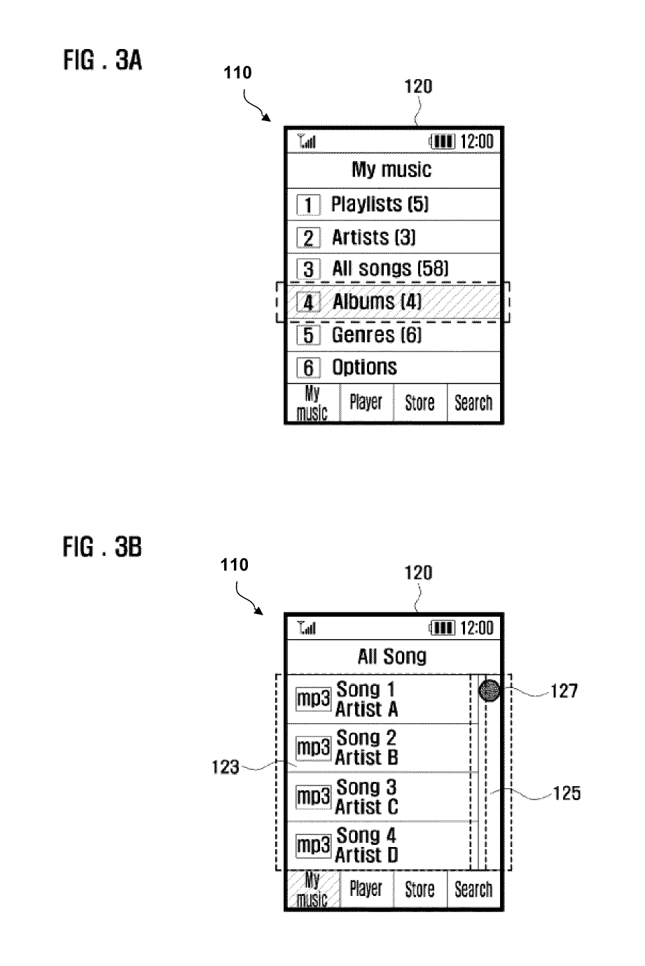

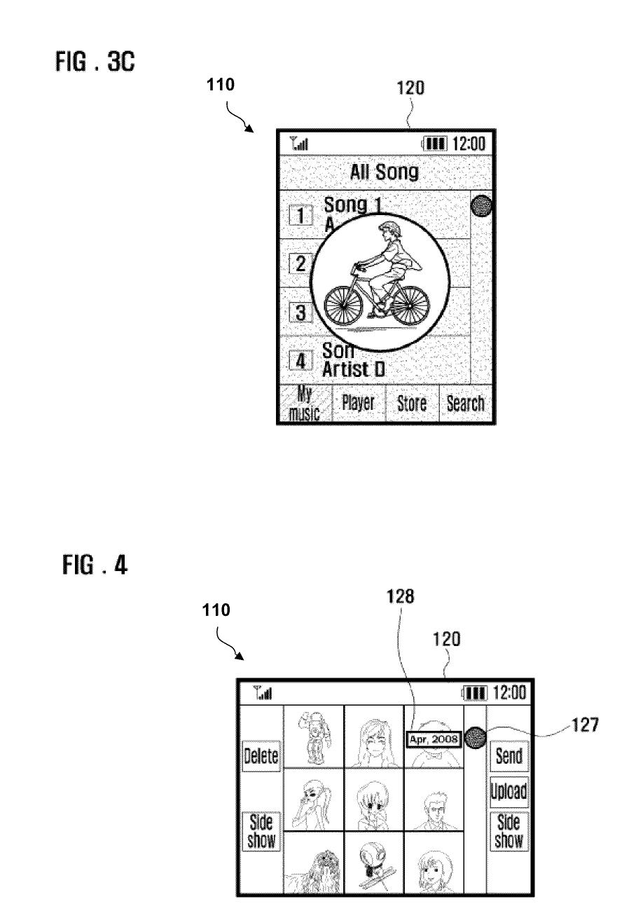

FIG. 4 is a diagram illustrating an exemplary screen image displaying tag information as the movement of the scroll button according to an exemplary embodiment of the present invention.

Although depicted in the form of an enlarged image in FIG. 2B, the tag information can be a presented in the form of a text balloon 128 as shown in FIG. 4 according to another exemplary embodiment. The text balloon 128 is a kind of popup window for presenting the value of tag information corresponding to the current position or the movement distance of the scroll button 127. For example, if the value of the tag information designated to the current position of the scroll button 127 is April 2008, the tag information value is presented in the text balloon 128 as shown in FIG. 4.

To this point, the data search operation according to exemplary embodiments using the scroll region 125 of the touchscreen have been described herein. Now, a method to search data using the data display region 123 according to an exemplary embodiment is described hereinafter.

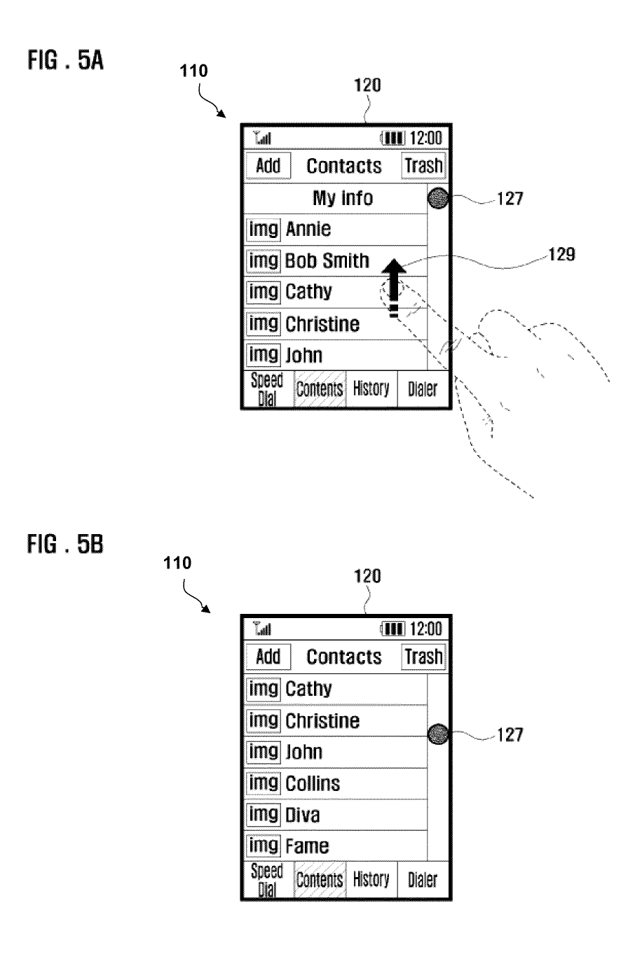

Once a touch event like a flick is detected on the screen displaying multiple data items, the data items move according to the touch event. At this time, the control unit of the mobile terminal checks a value of the tag information presented at the top of the display region 123 and moves the scroll button 127 onto the part of the scroll region 125 matched with the tag information value. The data search operation using the data display region 123 is described in more detail with reference to FIG. 5A and FIG. 5B.

FIG. 5A and FIG. 5B are diagrams illustrating exemplary screen images displayed on a touchscreen on which data search is performed according to an exemplary embodiment of the present invention.

As shown in FIG. 5A, if a flick event 129 is detected on the data display region 123 presenting a list of multiple data items, then the list is scrolled in the direction of the flick event such that the data items are rearranged. After the rearrangement of the data items, the control unit of the mobile terminal checks a value of the tag information presented at the top of the data display region 123 and moves the scroll button 127 onto the part of the scroll region 125 corresponding to the tag information value. For example, if a flick event occurs starting while the value “My info” of tag information is displayed at the top of the data display region as shown in FIG. 5A, the value is changed into “Cathy” as shown in FIG. 5B at the end of the flick event. In this case, the control unit of the mobile terminal checks the initial letter “c” of “Cathy” as the value of the tag information and the part designated for the value “c” in the scroll region 125. Next, the control unit places the scroll button 127 at the part designated for the value “c” of the tag information as shown in FIG. 5B.

To this point, how to present the data items in the data display region 123 and scroll button 127 in the scroll region 125, to change the value of tag information in accordance with the movement of the scroll button 127, and to display the data items in association with the tag information value have been described with exemplary screen images herein. The internal structure and operations of a mobile terminal according to an exemplary embodiment are now described hereinafter.

FIG. 6 is a block diagram illustrating a configuration of a mobile terminal having a touchscreen according to an exemplary embodiment of the present invention.

Referring to FIG. 6, the mobile terminal includes a touchscreen 110, a storage unit 140, and a control unit 150.

The touchscreen 110 works simultaneously as an input device for receiving user input and as a display device for displaying data. That is, the touchscreen 110 is provided with a display unit 120 and a touch sensing unit 130 as an input unit.

The display unit 120 may be implemented with a Liquid Crystal Display (LCD) that displays various data associated with operation status and information of the mobile terminal under the control of the control unit 150. Particularly when a stored data display mode is selected, the display unit 120 displays a display screen including a data display region 123 as a first display region and a scroll region 125 having a scroll button 127 as a second display region.

The touch sensing unit 130 is integrated with the display unit 120 and can be implemented with a touch panel or a touch sensor for detecting a touch event executed by the user. The touch sensing unit 130 generates an input signal corresponding to the detected touch event and sends the input signal to the control unit 150. When a touch event occurs, the touch sensing unit 130 analyses the variation of physical quantity on the touch panel or the touch sensor and converts the variation of the physical quantity to an electric signal and sends the electric signal to the control unit 150. Particularly, the touch sensing unit 130 detects the touch on the scroll button 127 placed on the scroll region 125 and movement of the touched point and the touch on the data display region 123 and movement of the touch point on the data display region 123.

The storage unit 140 stores various application programs and data associated with the operations of the mobile terminal and tag information about the data under the control of the control unit 150. The storage unit 140 can be implemented by at least one of volatile and nonvolatile memory devices.

The control unit 150 controls operations of the mobile terminal. Particularly, the control unit 150 controls the storage unit 140 and the touch screen 110 such that multiple data stored in the storage unit 140 are displayed in the data display region 123 and the scroll button 127 along with the scroll region on the touch screen 110 are also under the control of the control unit 150. The control unit 150 controls to sort the data displayed in the data display region 123 in order of tag information. The control unit 150 also controls such that the value of the tag information selected according to the position of the scroll button 127 is overlaid on the displayed data in an enlarged form.

In order to display the value of the tag information according to the movement of the scroll button, the control unit 150 matches the values of the tag information with parts of the scroll region 125. In more detail, the control unit 150 checks the number of the values of the tag information, divides the scroll region 125 into the number of the tag information values, and matches the divided parts of the scroll region 125 with the respective tag information values. Also, the control unit can match the value of the tag information with movement distances of the scroll button from a standard point on the scroll region 125. The parts of and distances on the scroll region 125 matched with the tag information values are stored in the storage unit 140 under the control of the control unit 150.

When the scroll button 127 is placed at a part on the scroll region 125 or at a distance from a standard point, the control unit 150 checks the value of the tag information corresponding to the part or the distance and displays the value of the tag information on the touchscreen 110 in the form of an overlaid image. In more detail, the control unit 150 detects the movement of the scroll button 127 on the scroll region 125 and displays the tag information value matched with the part at which the scroll button 127 is positioned or the distance of the scroll button 127 from the standard position.

When a flick event is detected on the data display region 123 listing the data items, the control unit 150 interprets the flick event as a scroll command signal so as to control the touch screen 110 such that the list of the data items is scrolled in the direction of the flick event, resulting in display of the scrolled data items in the data display region 123. At this time, the control unit 150 also checks the value of the tag information of the scrolled data items and places the scroll button 127 at a part on the scroll region 125 matched with the tag information value.

The control unit 150 controls the touchscreen 110 to display multiple data items sorted by their tag information value in the data display region 123 and the scroll button 127 at a part corresponding to the tag information value in the scroll region 125. Also, when the movement of the scroll button 127 is detected, the control unit 150 displays the value of the tag information matched with the part at which the scroll button 127 is placed to be overlaid on data display region 123 in an enlarged manner. The control unit 150 can scroll the list of the data items according to a scroll command input represented by a specific touch event, check the value of the tag information of the scrolled data items, and move the scroll button 127 to a part of the scroll region 125 designated for the tag information value.

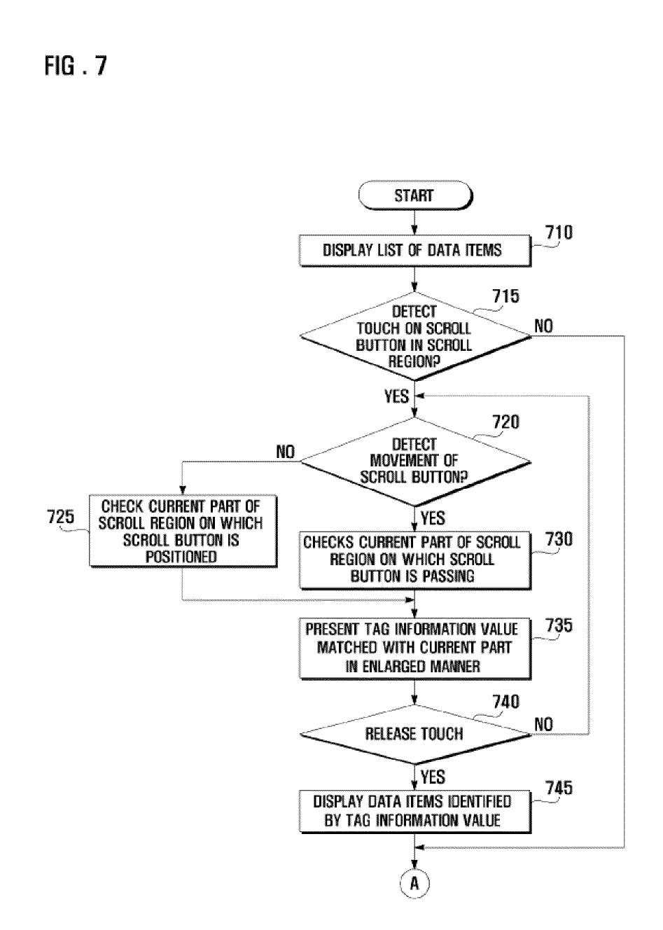

As described above, the data search method according to an embodiment of the present invention enables navigating data with touch events on the data display region 123 as the first region and the scroll button 127 on the scroll region 125 as the second region. The data search procedure using the scroll button 127 on scroll region 125 is described hereinafter with reference to FIG. 7.

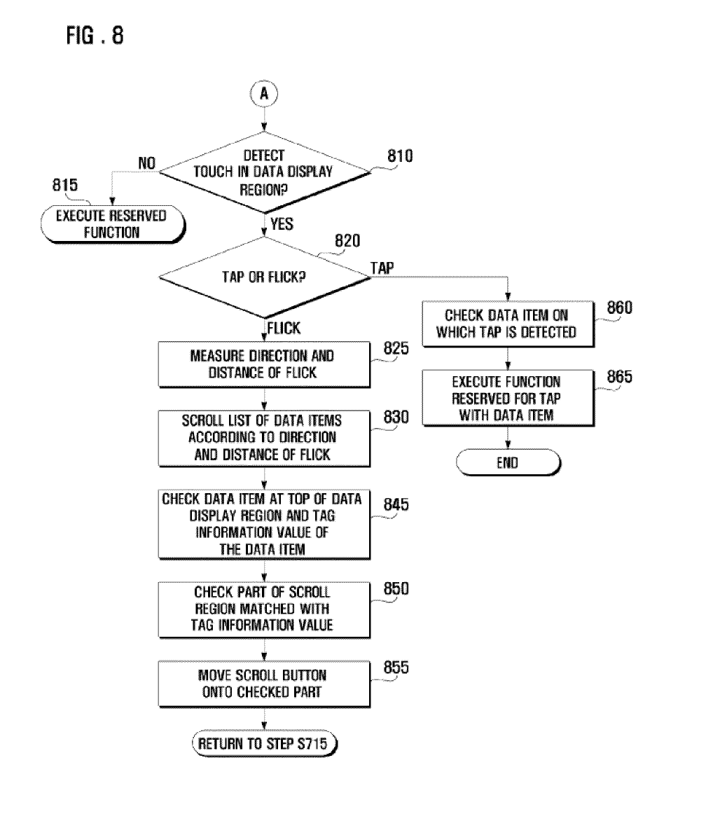

FIG. 7 and FIG. 8 show a flowchart illustrating a data search method for a touchscreen-enabled mobile terminal according to an exemplary embodiment of the present invention. FIG. 7 shows a data search procedure using the scroll button 127.

Referring to FIG. 7, if a data view mode such as a photo view mode, a music view mode, a message view mode, or an all data view mode is selected, the control unit 150 controls the touchscreen 110 to display a list of data items supported by the selected data view mode in the data display region 123 (S710). At this time, the control unit 150 controls the touchscreen 110 to display the scroll button at an appropriated position on the scroll region 125. For example, when the photo view mode is selected by the user, the control unit 150 retrieves the photo data stored in the storage unit 140 and displays a photo list listing the data items representing the retrieved photo data in the data display region 123. The data items can be sorted in descending order of created date of the photo data.

Next, the control unit 150 monitors to detect a touch on the scroll button 127 in the scroll region 125 (S715). Once a touch is detected on the scroll button 127, the control unit 150 monitors to detect a movement of the scroll button 127, i.e., the movement of the touch on the touchscreen (S720).

If no movement of the scroll button 127 is detected, then the control unit 150 checks the part of the scroll region 125 on which the scroll button 127 is currently positioned (S725). That is, when the scroll button 127 does not move during a predetermined period, the control unit 150 checks the current position of the scroll button 127 on the scroll region 125. After checking the current part on which the scroll button 127 is located, the control unit 150 displays the tag information value matched with the current part over the data display region 123 in an enlarged manner (S735).

Otherwise, if a movement of the scroll button 127 is detected at step S720, the control unit 150 checks the part on which the scroll button 127 is placed while moving along the scroll region 125 (S730). Whenever the scroll button is placed on a part of the scroll region 125, the control unit 150 controls such that the tag information value matched with the current part on which the scroll button 127 is placed is displayed over the data display region 123 in an enlarged manner (S735). That is, if the user touches the scroll button 127 on the touchscreen and moves the touch along the scroll region 125, the control unit 150 checks the current position of the scroll button 127 on the scroll region 125, refers to the tag information value matched with the current position, i.e. the part of the scroll region 125 on which the scroll button 127 is placed, and presents the tag information value on the touchscreen 110.

The control unit 150 monitors to detect whether the touch on the scroll button is released (S740). When the touch on the scroll button is not released, the control unit 50 repeats steps S720 to S740. Accordingly, the control unit 150 displays the tag information value changed due to the change of the part of the scroll region 125 on which the scroll button 127 is placed.

Otherwise, if the touch on the scroll button is released at step S740, the control unit 150 displays the tag information value matched with the part of the scroll region 125 at which the touch is released (S745). For example, if the user touches the scroll button 127 on the touchscreen 110 and drags the scroll button 127 along the touch scroll region 125, the control unit 150 displays the tag information values matched with the parts of the scroll region 125 on which the scroll button 127 is passing in sequential manner. If the tag information is the creation date of the photo data, then the control unit 150 controls such that the created dates of the photo data are sequentially displayed on the touchscreen 110. Once the touch on the scroll button 127 is released, the control unit 150 controls such that the created date matched with the part of the scroll region 125 at which the touch is released is displayed on the data display region 123.

That is, in order to search for the photo data created in April 2008, the user touches the scroll button 127 with a finger or a stylus on the touchscreen, drags the scroll button 127 to a part of the scroll region 125 matched with the value (April 2008) of the tag information (created date), and releases the touch from the touchscreen. The control unit 150 detects the touch point on the scroll button 127 and its movement and touch release, such that the control unit 150 moves the scroll button 127 along the scroll region 125 to the position at which the touch is released and displays the value of the tag information matched with the part of the scroll region 125 on which the scroll button is placed.

The data search procedure using the scroll button 127 of the scroll region 125 has been described herein. Although an embodiment of the data search procedure has been described with the scroll button 127 manipulation, in another embodiment, the data search can be performed by touching any point in the scroll region 125. For example, when a touch event is detected in the scroll region 125, the control unit 150 locates the point at which the touch event is detected and displays the tag information value matched with the part of the scroll region 126 at which the touch event has occurred. After showing the tag information value, the control unit 150 controls the display unit 120 of the touch screen 110 to display the data items identified by the tag information value.

A preferred embodiment of a data search procedure using the data display region 123 is described hereinafter with reference to FIG. 8. FIG. 8 shows a data search procedure using a data display region.

Referring to FIG. 8, if no touch is detected on the scroll button 127 at step S715 or after displaying the tag information value at step S745 (FIG. 7), the control unit 150 determines whether a touch occurs on the data display region 123 (S810). If touch is not detected on the data display region 123, the control unit 150 executes an associated function (S815). The function can be a camera function, an MP3 playback function, an internet access function, a text messaging function, a voice communication function, a video communication function, or the like.

Otherwise, if the touch is detected on the data display region 123, the control unit 150 determines whether the touch is a tap or a flick (S820). In this embodiment, the tap is a touch event for selecting a data item, and the flick is a touch event for scrolling a list of the data items displayed in the data display region 123.

When the touch event is a flick, the control unit 150 analyses the direction and distance of the flick (S825). Next, the control unit 150 scrolls the list of data items displayed in the data display region 123 according to the direction and distance of the flick (S830). For example, the flick is performed upward in a distance for three data items, the control unit 150 scrolls the list of data items upward such that the top three data items are scrolled out of the data display region 123 and the next three data items are scrolled up into the data display region.

Next, the control unit 150 checks the data item placed at the top of the data display region 123 and the value of the tag information of the top data item (S845). The control unit 150 checks the part of the scroll region 125 matched with the tag information value (S850) and moves the scroll button 127 onto the part of the scroll region matched with the tag information value (S855). Afterward, the control unit 150 may repeat the procedure from step S715 (FIG. 7).

If the touch event is a tap at step S820, the control unit 150 checks the data item on which the tap is detected (S860). Next, the control unit 150 executes a predetermined or user selected function in response to the data item being selected. The function can be one or more of displaying detailed information for a photo or playback for a video clip or a music file. Although the selection of a data item is done with a tap in this embodiment, the mobile terminal can be configured such that the data item can be selected by other types of touch events. For example, the control unit 150 can recognize an event in which a touch on a data item is released in a predetermined time as the selection event. If a touch event is detected in the data display region 123, the control unit 150 calculates the touch duration of the touch event and, if the touch duration satisfies a threshold value, regards the touch event as the selection command. The control unit 150 controls such that a function associated with the selected data item is executed. Also, the selection command can be mapped to a touch event having a relatively long time duration. In this case, if the touch time of the touch event lasts over a threshold duration, the control unit 150 checks the data item on which the touch event is detected and executes a command to be done with the selected data item.

How to search for data items in the mobile terminal having a touch screen according to exemplary embodiments has been described hereinabove. Although not described in detail, there can be a method for displaying information on one of the searched data items according to another exemplary embodiment.

For example, the data search method may further include a procedure to narrow down the search result in which, if a tap on the scroll button 127 is detected while a set of searched data items are displayed in the data display region 123, the control unit 150 checks the tag information value and segments the value into more detailed values. Next, the control unit 150 divides the scroll region 125 into the number of detailed values, matches the detail values with the respective parts of the scroll region 125, and monitors to detect the movement of the scroll button 127 along the newly scaled scroll region 125. If the movement of the scroll button 127 is detected, the control unit 150 presents the detail value of the tag information whenever the scroll button 127 is placed on a part of the resealed scroll region 125 and displays the data items of which tag information values are matched with the part of the scroll region 125 at which the touch on the scroll button 127 is released.

For example, when a set of photos created in the same month are displayed within the data display region by placing the scroll button 127 at the part matched with the tag information value, i.e. the month, on the scroll region 125 in the photo view mode, if a tap is detected on the scroll button 127, the control unit 150 segments the month into dates (e.g., days) and matches the dates with the parts of the scroll region 125 resealed into the range of the dates. Next, the control unit 150 determines to detect a touch on the scroll button 127. If a touch is detected on the scroll button 127, the control unit 150 presents the tag information value, i.e. the date designated to the part on which the scroll button 127 is placed and displays the photos created on the date matched with the part of the scroll region 125 on which the touch is released.

As described above, the data search method for a mobile terminal having a touch screen according to exemplary embodiments of the present invention enables the user to search for data items by checking tag information of the data items, which are scrolled by dragging a scroll button on the touchscreen without laborious keyword input.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A data search method for a terminal having a touchscreen, comprising:
displaying a list of data items and a scroll button in a first display region and a second display region of the touchscreen, respectively;
checking a current part of the second display region at which the scroll button is placed in response to a touch of the scroll button;
presenting a value of tag information matched with the current part; and
displaying, in response to a release of the touch of the scroll button, at least one data item identified by the value of the tag information in the first display region.

2. The data search method of claim 1, wherein checking a current part comprises:
monitoring to detect a movement of the scroll button; and
checking, in response to a detected movement of the scroll button, the current part of the second region at which the scroll button is passing.

3. The data search method of claim 2, wherein presenting a value of tag information comprises enlarging the value of the tag information.

4. The data search method of claim 3, wherein the tag information comprises a metadata for sorting the at least one data item.

5. The data search method of claim 1, further comprising:
detecting touch in the first display region;
determining a type of the touch in the first display region;
executing a function reserved for the type of the touch in the first display region.

6. The data search method of claim 5, wherein the type of the touch is one of a flick and a tap.

7. The data search method of claim 6, wherein executing a function reserved for the type of the touch comprises:
measuring, when the type of the touch is the flick, a direction and a distance of the flick;
scrolling the list of the data items according to the direction and the distance of the flick;
checking the value of tag information of at least one data item appearing in the first display region; and
moving the scroll button to a part of the second display region matched with the value of the tag information.

8. The data search method of claim 7, wherein checking the value of tag information comprises checking the value of the tag information of the data item placed at a top of the first display region.

9. The data search method of claim 7, wherein moving the scroll button to a part of the second display region comprises:
checking the part of the second display region matched with the value of the tag information; and
placing the scroll button on the checked part of the second display region.

10. The data search method of claim 6, wherein executing a function reserved for the type of the touch comprises:
checking, when the type of the touch is the tap, the data item on which the tap is occurred; and
executing a function reserved for the tap.

11. The data search method of claim 10, wherein the data item is any of a photo file, a music file, and a text file.

12. A terminal comprising:
a touchscreen to display a list of data items in a first display region and to display a scroll button in a second display region, the touchscreen to sense a touch thereon;
a storage unit to store the data items with values of tag information to sort the data items; and
a control unit to check, in response to a touch of the scroll button, a part of the second display region corresponding to the scroll button's location, to present the value of the tag information matched with the part, and to display, in response to a release of the touch of the scroll button, at least one data item identified by the value of the tag information in the first display region.

13. The terminal of claim 12, wherein the control unit is operable to monitor and detect a movement of the scroll button and to check, in response to the detected movement of the scroll button, the current part of the second display region at which the scroll button is passing.

14. The terminal of claim 13, wherein the control unit is operable to present the value of tag information in an enlarged manner.

15. The terminal of claim 13, wherein the control unit is operable to determine whether the touch is detected in the first display region, to analyze, in response to a detected touch in the first display region, a type of the touch, and to execute a function reserved for the type of the touch.

16. The terminal of claim 15, wherein the type of the touch is one of a flick and a tap.

17. The terminal of claim 16, wherein the control unit is operable to measure, when the type of the touch is the flick, a direction and a distance of the flick, to scroll the list of the data items according to the direction and the distance of the flick, to check the value of tag information of at least one data item appearing in the first display region, and to move the scroll button to a part of the second display region matched with the value of the tag information.

18. The terminal of claim 17, wherein the control unit is operable to check the part of the second display region matched with the value of the tag information, and to place the scroll button on the checked part of the second display region.

19. The terminal of claim 16, wherein the control unit is operable to check, when the type of the touch is the tap, the data item on which the tap is occurred, and to execute a function reserved for the tap.

20. The terminal of claim 19, wherein the data item is any of a photo file, a music file, and a text file.
